(19) United States
(12) Patent Application Publication
(10) Pub. No.: US 2024/0167290 A1
(43) Pub. Date: May 23, 2024

(54) COVERING ELEMENT

(71) Applicant: Parador GmbH, Coesfeld (DE)

(72) Inventors: Frank Petersen, Coesfeld (DE); Martina Dekomien, Recklinghausen (DE); Franziska Holterhaus, Ahaus (DE)

(73) Assignee: Parador GmbH, Coesfeld (DE)

(21) Appl. No.: 18/502,557

(22) Filed: Nov. 6, 2023

(30) Foreign Application Priority Data
Nov. 17, 2022 (DE) 10 2022 004 252.5

(51) Int. Cl. E04F 13/08; B32B 3/06; B32B 5/18; B32B 9/02; B32B 9/04; B32B 21/02; B32B 21/04; B32B 21/14; B32B 27/06; B32B 37/12; B32B 37/18; E04F 15/02; E04F 15/10; E04F 15/20

(52) U.S. Cl. CPC E04F 13/0866; B32B 3/06; B32B 5/18; B32B 9/02; B32B 9/042; B32B 9/045; B32B 21/02; B32B 21/042; B32B 21/047; B32B 21/14; B32B 27/065; B32B 37/12; B32B 37/18; E04F 13/0867; E04F 13/0894; E04F 15/02038; E04F 15/107; E04F 15/206; B32B 2255/08; B32B 2255/26; B32B 2266/025; B32B 2266/0278; B32B 2307/54; B32B 2307/554; B32B 2307/7376; B32B 2317/02; B32B 2317/16; B32B 2419/00; E04F 2201/0115; E04F 2201/023; E04F 2201/043

(57) ABSTRACT

A covering element for a floor, wall and/or ceiling covering, in particular a laminate covering element, with an upper layer structure, a stability layer of wood and/or of a wood-based material adjoining the rear side of the upper layer structure, an elastic and/or acoustically damping layer adjoining the rear side of the stability layer, and a carrier plate adjoining the rear side of the damping layer.

### CROSS-REFERENCE TO RELATED APPLICATION

The present application claims priority to German Patent Application No. 10 2022 004 252.5, filed Nov. 17, 2022, which is hereby incorporated herein by reference.

### FIELD

The invention relates to a covering element for a floor, wall and/or ceiling covering. In particular, the present invention relates to a laminate covering element and/or a covering element for a laminate floor and/or laminate covering. The covering element has an upper layer structure and a carrier plate.

### BACKGROUND

In the prior art, it is known that so-called damping layers, which can serve as impact sound and/or are provided for impact sound insulation, are provided for acoustic damping. In the prior art, it is also known to arrange such damping layers as a separate component underneath the covering or to connect them to the underside of the covering element. For example, the damping layer may be directly adjacent to the countermove of the covering element. Furthermore, the damping layer can also be provided to compensate for unevenness of the substrate. An improved arrangement and/or adaptation of the covering element to the substrate can consequently also be made possible via the damping layer.

In practice, however, it has been found that a damping layer directly connected to the covering element, for example, which is materially bonded to the countermove, cannot provide the desired impact sound insulation properties. For this purpose, it is usually imperative to lay separate insulation boards on the substrate. The covering elements must then be laid on these insulation boards.

A further disadvantage is that the laminate covering elements known in the prior art produce a hard underfoot feeling for the user and are comparatively stiff and/or hard to the touch. This ultimately reduces the comfort of a laminate floor. A flexible behavior of the laminate flooring element cannot be provided even with the additional integration of a damping layer.

### SUMMARY

It is now the object of the present invention to improve a covering element of the type mentioned above in terms of damping properties and in terms of comfort for the user.

The aforementioned object is solved according to the invention by a covering element for a floor, wall and/or ceiling covering, which is preferably composed of a plurality of covering elements, in particular a laminate covering element, the covering element having an upper layer structure, a stability layer, a damping layer and a carrier plate. The stability layer adjoins the upper layer structure on the rear side. The stability layer is further formed of wood and/or of a wood-based material and/or is made of wood and/or of a wood-based material. The damping layer adjoins the stability layer on the rear side. The damping layer is formed as an elastic and/or acoustically damping layer. The carrier plate in turn adjoins the damping layer on the rear side.

In this context, it is understood that further layers can also be arranged between the aforementioned layers, but do not have to be arranged. In any case, an order results starting from the upper layer structure according to the following structure:
upper layer structure—stability layer—damping layer—carrier plate
   Thus, the aforementioned use of the term “rear side” is to be understood as meaning that the upper layer structure is associated with the upper side of the covering element and the carrier plate is associated with the bottom side of the covering element.

In contrast to the prior art, according to the invention the damping layer is not arranged below but above the carrier plate and below a stability layer.

In the course of the invention, it has been found that the acoustic and/or elastic damping properties can be provided very well by arranging the damping layer above the carrier plate, while at the same time a perceptible comfort and/or resilient behavior under load of the covering element can be achieved without impairing the further, in particular mechanical, requirements on the covering element. The present inventive idea is particularly advantageous when used for a laminate covering element, in particular wherein preferably resinated and/or resin-treated paper can only be laminated to HDF/MDF, after which a limitation arises in the prior art. According to the invention, the production of the covering element can now be integrated into a laminating method to form a laminate.

However, if only the damping layer were to be arranged above the carrier plate, this would cause excessive indentation under load. Another problem would be that the damping layer could be damaged comparatively easily and a permanent relief structure would develop after only a short period of use due to the stress on the covering element.

These disadvantages can be avoided by using the stability layer according to the invention. In the invention, therefore, it is precisely the stability layer and the damping layer that are important. According to the invention, it has been found that by arranging the stability layer above the damping layer, the damping properties and also the comfort of the covering element can be improved, while at the same time the damping layer can also be protected in particular from mechanical stresses. Furthermore, the stability layer can also avoid disturbing relief contours that would otherwise be created by the stress on the damping layer. The stability layer thus ensures that the specified and desired structure is present on the outer surface of the covering element, which is preferably not changed, or if so only slightly and/or minimally changed, by mechanical stressing of the covering element. At the same time, however, the damping layer also causes and/or ensures a certain flexible behavior of the covering element.

Furthermore, it has been found in accordance with the invention that the stability properties required to balance the damping layer can be optimally achieved by forming the stability layer from wood and/or a wood-based material. The stability layer can distribute the load when stressed, which in turn leads to lower punctual loads on the damping layer. Accordingly, a guaranteed load distribution for the damping layer leads to a large-area load that can be compensated accordingly without punctual load peaks. However, the comfort perceived by the user can still be ensured by the damping layer, and/or only in accordance with the invention.

The formation of the stability layer from wood and/or from a wood-based material is to be understood in particular as meaning that the material of the stability layer consists of wood or largely comprises wood (i.e. more than 50% by weight). Insofar as the stability layer is formed from wood-based material, this is to be understood to mean in particular that the stability layer is formed as a hard fiberboard, such as a medium-density fiberboard (MDF), high-density fiberboard (HDF), medium-hard wood fiberboard (HFM) and hard wood fiberboard (HFH). Such wood fiberboards are known in the prior art.

Wood fiberboards further consist primarily of wood. In this regard, the stability layer may comprise at least a proportion of wood of at least 70% by weight, preferably at least 75% by weight, more preferably at least 80% by weight. In addition to wood, the stability layer may also comprise additional material that may serve to reinforce and/or cohere the wood layer. For example, the stability layer may also comprise water, particularly due to the moisture content of the wood, and/or adhesive and/or resin. The water content may be between 1 to 10% by weight, preferably between 4 to 6% by weight. The adhesive and/or resin content can be up to 15% by weight, in particular up to 10% by weight. Other additives, such as for wax emulsion, may also be provided, but these may then account for less than 1% by weight of the material of the stability layer.

The material of the stability layer results in particular in a raw density of the stability layer between 600 and 1200 kg/m³, preferably between 600 and 1000 kg/m³. Particularly preferably, the stability layer is thus designed as a wood fiberboard or as a wood layer.

A wood fiberboard can have highly comminuted wood, as previously explained. Different types of wood fiberboard can differ from each other in terms of hardness and/or material density. Fiberwood is not the same as chipwood, even if these products are a residual product of the sawmill industry. However, chipboards contain chips with a significantly higher thickness than fiberboards, which contain very small wood fiber components.

A wood fiberboard can be achieved, in particular, by pressing the material.

In a particularly preferred embodiment, the covering element is designed to be polyvinyl chloride-free (PVC-free). A PVC-free design of the covering element results in the advantage that a particularly advantageous floor can be achieved, especially from an ecological point of view. PVC flooring and/or covering elements containing PVC are, in particular, resilient floor coverings. In the state of the art, it is common practice to add plasticizers to PVC flooring. However, plasticizers are not entirely harmless to health, so health concerns arise in practice for PVC flooring. It is therefore advantageous to provide a plasticizer-free or PVC-free floor via plasticizer-free or PVC-free covering elements.

However, the present invention does not preclude that in further alternative embodiments, the covering element contains at least in part polyvinyl chloride and/or in small amounts (<5% by weight). In particular, the upper layer structure may contain or consist of PVC. It is essential to the invention, in particular, that the stability layer is formed from wood and/or a wood-based material. This can also be combined with a PVC-containing upper layer structure, while at the same time ensuring the above-mentioned particularly advantageous properties of the covering element.

It is particularly preferred that the stability layer is plastic-free or at least essentially plastic-free. A plastic-free design does not preclude the stability layer from containing adhesive and/or resin, in particular if this does not consist of plastic. By an at least essentially plastic-free design of the stability layer it is preferably to be understood that the stability layer has a plastic content in the material of less than 5% by weight, preferably less than 3% by weight, more preferably less than 1% by weight.

It is particularly preferred that the carrier plate and/or the covering element has connecting geometries on the edge sides, in particular tongue-and-groove connecting geometries of a click connection, for connecting adjacent covering elements, preferably for forming a covering. In this context, the carrier plate can have connecting geometries of complementary design on opposite edge sides. For example, the longitudinal sides of the carrier plate and/or of the covering element can have connecting geometries which are complementary to one another, and the front sides, which can also be referred to as head sides, can also have connecting geometries which are complementary to one another. For example, a groove can be provided on one edge side, which is provided to cooperate with the tongue on the opposite edge side, which is formed complementary to the groove, so that a click connection can preferably be ensured.

In a further preferred embodiment of the invention, it is provided that the stability layer has a thickness between 0.3 to 5 mm, preferably between 0.5 to 2 mm. In tests carried out during the development of the invention, it was found that the stability properties of a stability layer formed from wood or a wood-based material can be reliably ensured at the above-mentioned thicknesses.

Preferably, the damping layer has a thickness and/or material thickness between 0.3 to 5 mm, preferably between 0.5 to 2 mm. The thicknesses of the damping layer and the stability layer can correspond to each other or differ from each other. The thicknesses of the stability layer and the damping layer are to be selected according to the desired damping and stability properties and also according to the desired perceptible comfort for the user.

The thickness of the carrier plate can be selected depending on the use of the covering element. It is particularly preferred if the carrier plate has a thickness of between 2 mm to 15 mm, preferably between 4 to 10 mm, more preferably between 6 to 9 mm.

Furthermore, the upper layer structure may comprise a decorative layer and/or an upper wear layer. In particular, a decorative film and/or a decorative paper and/or a decorative print and/or a decorative lacquer layer can be provided as the decorative layer. The upper wear layer may be in the form of an overlay, in particular an overlay containing corundum, and/or a protective lacquer and/or protective oil and/or a protective film.

The overlay can preferably comprise as material polyurethane (PUR) and/or consist of it. In particular, the wear layer is designed as a protective overlay film comprising PUR. PUR enables a high degree of sound absorption. Thus, the wear layer can also ensure a damping effect in addition to the damping layer through this choice of material.

The protective film may in particular comprise polypropylene (PP), polyethylene (PE) and/or polyurethane (PUR) as material. As previously explained, it may also be provided that the upper layer structure may also comprise PVC. The upper wear layer may be a wear layer disposed on the upper side, which may preferably be resinous. In particular, the upper wear layer may comprise corundum particles, whereby it can be formed as a wear layer. Corundum is particularly suitable because of its great hardness. As a result, the corundum particles can provide increased protection for the decorative paper, which is preferably resin-coated and/or (through-)impregnated.

Preferably, the upper layer structure may also comprise a wood veneer layer and/or a wood cover layer. However, the wood veneer and/or wood cover layer can also be covered and/or sealed and/or protected by an upper wear layer.

In further embodiments, it may also be provided that the stability layer is in the form of a wood veneer layer and/or a wood cover layer, and the upper layer structure is a sealing layer provided on top of the stability layer and/or an upper wear layer, in particular in which case the upper layer structure no longer needs to have a decorative film or decorative layer.

In a further preferred embodiment, it is provided that the stability layer, as explained above, is formed as a hard fiberboard, in particular MDF (medium-density fiberboard) and/or HDF (high-density fiberboard) and/or HFM/MB (medium-hard fiberboard) and/or HFH/HB board (hard fiberboard/hard board), and/or as a wood layer, in particular of poplar or lime. Materials of the aforementioned type ensure in particular the stability properties according to the invention.

Alternatively or additionally, it can be provided that the stability layer is formed as a shaped fiberboard, in particular a shaped natural fiberboard. In the case of natural fibers, natural materials and/or recycled fibers can be used in particular. Particularly preferably, the stability layer formed as a shaped fiberboard comprises and/or consists of recycled materials, in particular cellulose fibers and/or agricultural waste. Shaped fiberboards of the aforementioned type are particularly suitable as a substitute for MDF and/or HDF boards. Preferably, biodegradable shaped fiberboards are used, which are accordingly particularly advantageous from an ecological point of view. Shaped natural fiberboards for the stability layer can have as material fibers and/or components selected from the group of old newspapers, cardboard and agricultural by-products, in particular straw, bagasse and/or animal excrements. When used as a stability layer according to the invention, shaped fiberboards formed in this way are preferably free of harmful substances, have a high load-bearing capacity and are low in weight.

According to a particularly preferred embodiment, the damping layer has cork as a material and/or consists thereof. In this embodiment, the damping layer can preferably have a raw density between 150 to 550 kg/m³, preferably between 200 to 300 kg/m³. In addition, the damping layer may comprise a cork composite material, in particular comprising cork and polypropylene, polyethylene, polyurethane and/or an elastic plastic.

Alternatively or additionally, in further preferred embodiments, it can also be provided that the damping layer has as material a foam material, preferably a plastic foam material, and/or consists thereof. The foam raw density for the damping layer can then in turn depend on the selected type of plastic and the material thickness. In particular, when the damping layer is formed as a foam layer, the raw density can be between 100 to 200 kg/m³, in particular for a foam material comprising polyethylene, and/or 250 to 450 kg/m³, in particular for a material comprising polyurethane (PUR), in particular wherein the damping layer for the aforementioned raw densities can have a material thickness between 0.5 to 2 mm. In principle, it can also be provided that the plastic and/or foam material of the damping layer can be crosslinked.

Furthermore, according to the invention, the damping layer can have a modulus of elasticity of at most 5 MPa, preferably between 0.2 to 5 MPa, more preferably between 2 to 4 MPa. The modulus of elasticity was measured in particular as part of a tensile test. In this context, the modulus of elasticity is a material parameter which, in the case of linear-elastic behavior, describes the proportional relationship between stress and strain during the deformation of a solid body.

Advantageously, a countermove is provided on the underside of the carrier plate. In particular, the countermove can ensure that undesirable deformation of the covering element can be avoided. Ultimately, the countermove can compensate for forces acting on the carrier plate. In this way, the countermove compensates for stresses in the covering element. In the prior art, a countermove made of a veneer, a paper, in particular a kraft paper, and/or a film is typically used.

Preferably, the carrier plate is designed as a plate body, in particular as a wooden plate body, and/or as an HDF and/or MDF plate and/or as a plate body comprising or consisting of plastic. Accordingly, in further embodiments, it can also be provided that the carrier plate has a plastic material and/or consists of plastic.

Furthermore, in another preferred embodiment of the invention, it may be provided that at least two layers of the covering element and/or the damping layer, the carrier plate, the stability layer and/or the upper layer structure have been pressed together, preferably to form a laminate. In particular, at least one layer, preferably at least one layer of the upper layer structure, preferably the decorative paper, and/or the countermove, may be resinated. In particular, a melamine resin is provided as the resin. It is particularly preferred if the resinated layer is at least substantially completely resinated and/or impregnated through.

In particular, melamine resin can also contain other fillers, especially polyurethane (PUR).

Alternatively or additionally, it can be provided that at least two layers, preferably all layers, of the covering element have been adhered to one another, in particular wherein the carrier plate, the stability layer and the damping layer are adhered to one another.

In a particularly preferred embodiment, at least two layers of the covering element are pressed together and at least two further layers are adhered together. It is particularly advantageous if the carrier plate, the stability layer and the damping layer are adhered to each other and, in turn, the preproduct formed in this way is then pressed together with the, in particular resinated, upper layer structure and the, in particular resinated, countermove. Alternatively, it is also possible to laminate the countermove and/or the upper layer structure with the adhered preproduct. Particularly preferably, the countermove is soaked with melamine resin prior to the pressing process. Alternatively or additionally, it is preferred that the upper layer structure, in particular the decorative layer, preferably the decorative paper, and/or the overlay, has/have been soaked with melamine resin before the pressing process.

The aforementioned method steps, which will be discussed later in connection with the method according to the invention, are also to be regarded as product features, since they are evident in the end product.

Furthermore, the aforementioned object is solved by a method for producing a covering element according to one of the aforementioned embodiments. According to the invention, the method comprises the following method steps:
A) Providing a carrier plate and a stability layer;
B) Bonding the carrier plate to a damping layer, preferably by extruding the damping layer at least indirectly onto the carrier plate and/or preferably by pressing and/or laminating the carrier plate and the damping layer together;
C) Bonding the damping layer to the stability layer, preferably by means of pressing and/or laminating;
D) Bonding the stability layer to an upper layer structure, preferably by means of pressing and/or laminating.

It is understood that with regard to advantages and preferred embodiments of the method according to the invention, reference may be made to the previously discussed advantages and embodiments of the covering element, which may also apply in the same way to the method according to the invention, without this requiring any further explicit mention. Likewise, it is understood in accordance with the invention that the following explanations of the method according to the invention may also apply in the same way to the covering element according to the invention, without this requiring any further explicit mention.

In a preferred embodiment of the method, it can be provided that method steps B) and C) and/or C) and D) are carried out simultaneously. In particular, the layers of the covering element can be pressed and/or adhered to one another and/or laminated to one another at least simultaneously. The combination of adhering and pressing of the layers can also be provided, for example by adhering some layers together and pressing them to form further layers.

For pressing the layers together, it is advantageous if at least one layer of the covering element is resinated. For the purposes of the present invention, a resin coating is also understood to mean an at least partially impregnated or thoroughly impregnated formation of the layer.

According to the invention, it can also be provided that for pressing two layers between these layers, a bonding layer of resin, preferably a melamine resin, is provided.

Regardless of whether the resination is provided by resinating one layer of the covering element or by an additional bonding layer integrated in the covering element, a pressing process, preferably in a short-cycle (German: KT) pressing plant, enables a permanent and secure bonding of the layers to be ensured.

If a bonding layer is used to join two adjacent layers during pressing, it is applied to the at least one layer on the side facing the other layer before pressing.

The resin for pressing, which is provided in at least one layer, is in particular at least one aminoplastic, thermoplastic or thermosetting resin or reactive resin, in particular melamine resin. In this context, the resin is preferably characterized by the fact that it first liquefies under the influence of temperature and pressure and then hardens and/or reacts. During activation of the resin, preferably of the decorative layer and/or of the countermove, the resin penetrates in particular into the pores of the adjacent layers, so that penetration into both layers takes place, resulting in a firm bond to the adjacent layer.

Furthermore, it can be provided that bonding layers made of a resin material can be used in addition to the aforementioned layers of the covering element. These bonding layers can then be arranged between the layers to be pressed. In this case, a resin of the aforementioned type can then be provided in the bonding layer, which, when pressed, enters the adjacent layers and bonds them to one another in a materially cohesive manner.

The temperature during pressing is essentially dependent on the resin material to be selected. Preferably, pressing is carried out at a temperature greater than 80° C. The pressing temperature refers to the temperature at the press plate of the press. It is therefore applied to the upper side and bottom side of the covering element.

In the case of thermosetting resins or reactive resins, higher temperatures are required, so that pressing takes place at a temperature in particular between 180° C. and 210° C. In the case of resins in the form of urea-formaldehyde condensation products, the pressing temperature level is lower compared with reactive resins and is in particular in the range between 100° C. and 140° C. Urea-formaldehyde condensation products belong to the group of urea resins and thus also to the aminoplastic resins.

In addition, a sufficiently high press pressure must be present in the press to cure the resin layer. In particular, a short-cycle press is provided as the press. The press pressure is preferably greater than or equal to 1000 kPa and/or 100 N/cm², preferably greater than 3500 kPa and/or 350 N/cm².

Preferably, the upper layer structure may have been provided prior to bonding with the stability layer or may be produced during bonding with the stability layer. In addition, the upper layer structure can also be formed as a single or multilayer structure. In the case of a multilayer design of the upper layer structure, it is advantageous if this has at least one resin-coated layer or a bonding layer made of resin, in particular if the upper layer structure is intended for subsequent pressing.

In a particularly preferred embodiment of the method according to the invention, it is provided that first the carrier plate, the damping layer and the stability layer are adhered together and then pressed with the, in particular at least partially resinated and/or impregnated, preferably completely resinated and/or impregnated, upper layer structure and optionally with the, preferably resinated and/or impregnated, countermove. Alternatively, it can be provided that first the carrier plate, the damping layer and the stability layer are bonded to each other and then the upper layer structure and optionally the countermove are laminated.

In a further preferred alternative, it can be provided that first the, in particular resin-coated, upper layer structure is pressed with the stability layer and optionally the, preferably resin-coated, countermove is pressed with the carrier plate—in each case separately—and then the damping layer is laminated with the stability layer and the carrier plate.

The aforementioned method embodiments present different possibilities for forming a covering element. In this context, the respective method can be adapted according to the materials of the covering element.

In the aforementioned possibilities of the method embodiment for producing the covering element, it is provided that a so-called preproduct is used. According to the aforementioned embodiments of the method according to the invention, a preproduct is achieved by adhering the damping layer, the stability layer and the carrier plate. The provision of a preproduct is associated with the advantage that the production can be simplified as well as the storage costs can ultimately be reduced, since the preproduct can be bonded to different upper layer structures which, for example, have different decors.

In addition to the previously mentioned preproduct, other preferred preproducts can also be provided. Furthermore, more than one preproduct can also be provided in the method according to the invention for producing the covering element.

Particularly preferably, the preproduct can be stored temporarily. In a further preferred embodiment, it can be provided that the preproduct is formed by bonding the damping layer, the stability layer and the upper layer structure, or by bonding the carrier plate to the damping layer, or by bonding the stability layer to the upper layer structure, or by bonding the carrier plate, the damping layer and the stability layer. Bonding of the aforementioned layers can preferably be ensured either by adhering and/or laminating and/or by a pressing process.

Preferably, it is provided that on a preproduct, formed by bonding the carrier plate, the damping layer and the stability layer, the upper layer structure can subsequently be laminated and/or adhered and/or printed and/or lacquered. Adhering of the upper layer structure to the aforementioned preproduct is particularly preferred for carrier plates comprising a plastic, such as polyethylene, polypropylene and/or PVC, and/or for a parquet covering element.

In a further embodiment of the method according to the invention, it is provided that two preproducts are provided to form the covering element. One preproduct can then be provided by bonding the upper layer structure to the stability and damping layer, wherein another preproduct can be formed by the carrier plate and the countermove. Both pre-products can then be adhered together.

In addition, according to a further preferred embodiment, it is provided that after the layers of the covering element have been bonded, the edge-side connecting geometries are introduced into the covering element, in particular into the carrier plate. Alternatively, it can also be provided that the connecting geometries have already been provided in the carrier plate before bonding with the further layers to form the covering element.

Furthermore, it is expressly pointed out that all the above and following intervals contain all the intermediate intervals and also individual values contained therein and that these intermediate intervals and individual values are to be regarded as essential to the invention, even if these intermediate intervals or individual values are not specifically indicated in detail.

Further features, advantages and possible applications of the present invention will be apparent from the following description of examples of embodiments based on the drawing and the drawing itself. In this context, all the features described and/or illustrated constitute the subject-matter of the present invention, either individually or in any combination, irrespective of their summary in the claims or their relation back.

### BRIEF DESCRIPTION OF THE DRAWINGS

It shows:

FIG. 1 is a schematic layer structure of a covering element according to the invention,

FIG. 2 is a schematic layer structure of a further embodiment of a covering element according to the invention,

FIG. 3 is a schematic layer structure of a further embodiment of a covering element according to the invention,

FIG. 4 is a schematic perspective view of a covering element according to the invention,

FIG. 5 is a schematic perspective view of a covering according to the invention,

FIG. 6 is a schematic representation of a method according to the invention,

FIG. 7 is a schematic representation of a method step according to the invention for forming a preproduct according to the invention,

FIG. 8 is a schematic representation of a further embodiment of a method according to the invention,

FIG. 9 is a schematic representation of a further embodiment of a method according to the invention, and

FIG. 10 is a schematic representation of a further embodiment of a method according to the invention.

### DETAILED DESCRIPTION

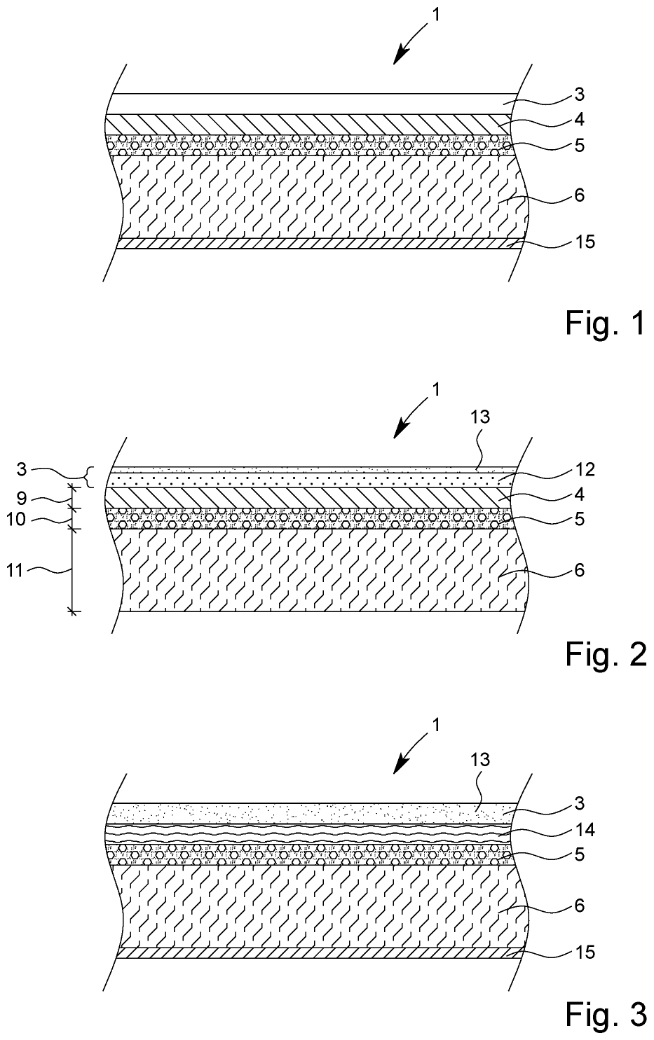

FIG. 1 shows a layer structure of a covering element 1. The covering element 1 is intended for use to form a floor, wall and/or ceiling covering 2. To form a covering 2, several covering elements 1 can be connected to each other. A covering 2 is shown schematically in FIG. 5. In particular, a laminate covering element is provided as the covering element 1.

FIG. 1 shows that the covering element 1 has an upper layer structure 3. The upper layer structure 3 can be single-layer or multilayer. A stability layer 4 adjoins the upper layer structure 3 on the rear side. The stability layer 4 is made of wood and/or a wood-based material. As FIG. 1 shows, a damping layer 5 adjoins the stability layer 4 on the rear side. The damping layer 5 is an elastic and/or acoustically damping layer. In turn, a carrier plate 6 adjoins the damping layer 5 on the rear side. The carrier plate 6 can be designed as a plate body. In the embodiment example shown in FIG. 1, a countermove 15 is also provided, which can optionally be provided on the rear side of the carrier plate 6.

A multilayer design of the upper layer structure 3 is shown in FIG. 2, among others.

The stability layer 4 consists to a large extent of wood, wood particles and/or wood fibers. In particular, the material proportion of wood, which can be provided as coherent wood, wood particles and/or wood fibers, in the stability layer 4 is at least 65% by weight, preferably at least 70% by weight, in particular at least 80% by weight.

The damping layer 5 ensures the damping properties for the covering element 1. The damping layer 5 can ultimately provide a high level of comfort on the upper side of the covering element 1, which ultimately represents the useable side. Via the stability layer 4, on the other hand, load balancing/load distribution can be ensured when the covering element 1 is subjected to loads, in particular when mechanical stresses act on the covering element 1, such as walking on a floor covering 2. The load distribution can ultimately ensure a long service life for the covering element 1, while at the same time also making advantageous use of the damping properties of the damping layer 5. The stability layer 4 also protects the damping layer 5 from further external influences, so that the functionality of the damping layer 5 can be guaranteed over a long period of use.

Furthermore, the integration of the damping layer 5 in the layer structure of the covering element 1 has the advantage that a separate provision of a damping layer 5 underneath a covering 2 can be omitted, which can significantly reduce the installation effort for a damping floor covering 2. In particular, the covering element 1 shown in the embodiments can be laid in a manner known to the user without requiring any further special modification during laying. This also reduces laying errors.

The covering element 1 shown in FIG. 1 is PVC-free. However, the covering element 1 shown in FIG. 3 also contains PVC as a material.

Furthermore, the stability layer 4 shown in FIG. 1 is designed to be plastic-free or at least substantially plastic-free. A plastic-free design of the stability layer 4 does not exclude the possibility that it may have a resin content or an adhesive content, in particular for bonding the wood fiber components. Preferably, the plastic content of the material of the stability layer is less than 5% by weight, preferably less than 1% by weight, which is to be understood by a plastic-free formation of the stability layer 4.

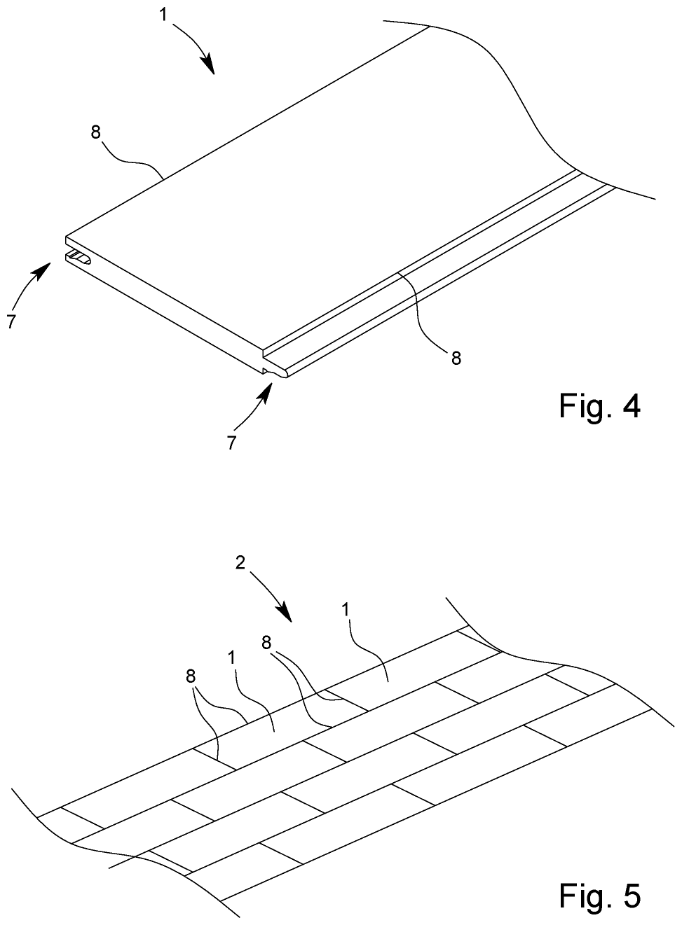

In FIG. 4, it is shown that the carrier plate 6 and also the covering element 1 have connecting geometries 7 on their longitudinal sides. It is not shown in more detail that these connecting geometries 7 can also be provided on the head sides. In particular, tongue-and-groove connecting geometries of a click connection for connecting adjacent covering elements 1 are provided as connecting geometries 7. Preferably, the connecting geometries 7 are formed on opposite edge sides 8 of the carrier plate 6 and/or of the covering element 1 in a complementary manner. Thus, one long side can have a groove and the opposite long side can have a tongue formed complementary to the groove for forming the click connection. The connecting geometries 7 can ultimately be used to connect adjacent covering elements 1 to one another to form a covering 2, as shown schematically in FIG. 5.

FIG. 2 shows different thicknesses of the individual layers of the covering element 1. The stability layer 4 shown in FIG. 2 can have a thickness 9 between 0.3 to 5 mm, in particular between 0.5 to 2 mm. The damping layer 5, in turn, may have a thickness 10 between 0.3 to 5 mm, in particular between 0.5 to 2 mm. The thicknesses 9, 10 of the stability layer 4 and of the damping layer 5 can be at least substantially equal to one another or differ from one another.

Furthermore, the carrier plate 6 can have a thickness 11 between 2 to 15 mm, preferably between 4 to 10 mm. The thickness 11 of the carrier plate 6 is selected depending on the desired construction height and/or overall height of the covering element 1.

In FIG. 2, it is shown that the upper layer structure 3 has a decorative layer 12 and an upper wear layer 13. It is not shown in more detail that the upper layer structure 3 has only one decorative layer 12 or only one upper wear layer 13. The decorative layer 12 may be a decorative film, a decorative paper, a decorative print and/or a decorative lacquer layer. In turn, a protective film, an overlay and/or a protective lacquer and/or protective oil may be provided as the upper wear layer 13. The overlay in particular has corundum particles and/or is formed to contain corundum. This ultimately increases the resistance to wear.

It is not shown in more detail that the overlay has polyurethane (PUR) as a material and/or consists thereof. In particular, the upper wear layer 13 is designed as an overlay and as a protective film, the material of which is PUR and/or consists thereof. This design of the wear layer 13 ensures a sound-absorbing behavior of the wear layer 13.

The upper layer structure 3 may have a wood veneer and/or a wood cover layer 14. In FIG. 3, it is shown that the stability layer 4 is formed as a wood veneer and/or wood cover layer 14. Then, the stability layer 4 can also be considered as part of the upper layer structure 3. An upper layer structure 3 or an upper wear layer 13 for protecting the wood can then be applied to the wood veneer and/or wood cover layer 14, in particular a coating.

The stability layer 4 shown in FIG. 2 is designed as a hard fiberboard. In this context, various hard fiberboards are suitable, in particular a MDF and/or HDF board and/or a HFM/MB and/or a HFH/HB board. Alternatively, it can also be provided that the stability layer 4 is formed as a wood layer, in particular of poplar or lime. In this embodiment, it is particularly preferred if the stability layer 4 is formed as a wood veneer and/or wood cover layer 14, as previously explained, and in particular consists of poplar or lime.

It is not shown that the stability layer 4 is designed as a shaped fiberboard, in particular a shaped natural fiberboard. In particular, the shaped fiberboard may comprise waste cellulose as a material and/or consist thereof. Alternatively or additionally, the stability layer 4 formed as a shaped fiberboard may comprise and/or consist of recycled materials, in particular cellulose fibers and/or agricultural waste. In particular, the stability layer is designed as a flexible, high-density and compressed shaped fiberboard made of waste cellulose, which is preferably biodegradable.

The damping layer 5 shown in FIG. 1 has as material cork and/or a cork composite, in particular comprising cork and polypropylene (PP), polyethylene (PE) and/or polyurethane (PUR) and/or other elastic plastics. In further embodiments, it may be provided that the damping layer 5 comprises and/or consists of a foam material, in particular a plastic foam material. The foam material may also be cross-linked.

In addition, the damping layer can have a modulus of elasticity of at most 5 MPa and in particular between 2 to 4 MPa.

As previously explained, FIG. 1 shows that a countermove 15 is arranged on the underside of the carrier plate 6, which ultimately leads to the load distribution. In particular, a kraft paper can be provided as the countermove 15. In principle, the countermove 15 can be of single-layer or multi-layer design.

The carrier plate 6 shown in the embodiments is designed as a plate body and can be provided in particular as a hard fiberboard, preferably as a HDF and/or MDF board. In further embodiments not shown in more detail, the carrier plate 6 may also comprise or consist of a plastic material.

The layers of the covering element 1 can be bonded to each other in different ways, but this can also be seen in the final product as such.

Thus, at least two layers of the covering element 1 and/or the damping layer 5, the carrier plate 6, the stability layer 4 and/or the upper layer structure 3 may have been pressed together. In the case of pressing, it is particularly preferred if at least one layer is resinated, in particular at least one layer of the upper layer structure 3 or of the countermove 15.

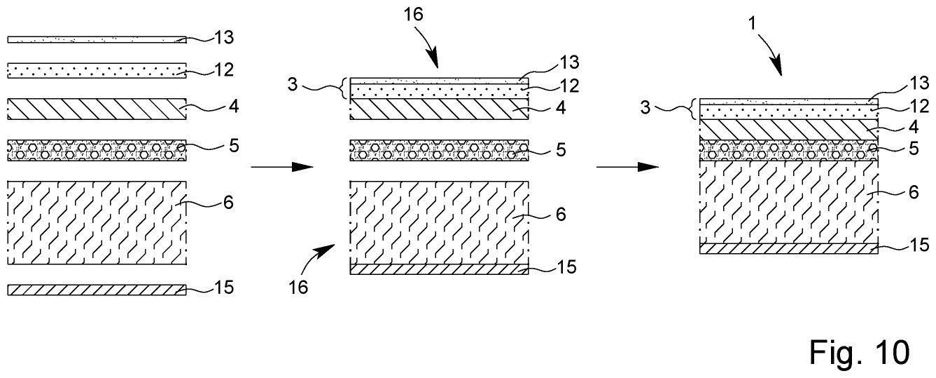

FIG. 10 shows, for example, that the upper layer structure 3 has been pressed together with the stability layer 4 and the carrier plate 6 has been pressed together with the countermove 15, wherein in this connection the countermove 15 and the decorative layer 12 have been resinated and/or through-impregnated.

During pressing, a resin bonding layer can alternatively also be arranged between the layers to be pressed, which penetrates into the adjacent layers during pressing and bonds them firmly/materially to one another. Melamine resin is preferably provided as the resin.

Alternatively or additionally, it can also be provided that preferably two layers, in particular all layers, of the covering element 1 have been adhered together. In particular, the carrier plate 6, the stability layer 4 and the damping layer 5 can be adhered together, as shown for example in FIG. 9. Also, an adhering of the layers may be combined to a pressing of other layers, as it will be described in connection with the method.

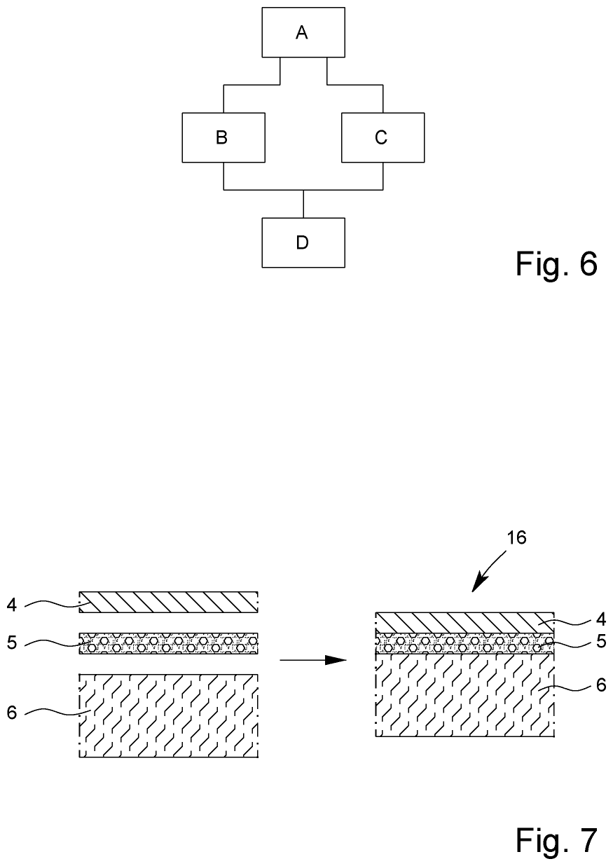

FIG. 6 shows a schematic process flow of a method for producing a covering element 1 according to one of the embodiments described above. The method comprises steps A) to D). In step A), the carrier plate 6 and the stability layer 4 are first provided.

In method step B), the carrier plate 6 is then bonded to a damping layer 5. Bonding can take place, for example, by extrusion of the damping layer 5 onto the carrier plate 6, in particular if the material of the damping layer 5 is foam or consists thereof. Alternatively, it can be provided that the carrier plate 6 and the damping layer 5 are pressed and/or laminated to each other, wherein a connection to further layers of the covering element 1 can also be carried out during this connection method.

In the process flow shown in FIG. 6, method step C) is carried out at the same time as and/or simultaneously with method step B). However, a temporally independent execution can also be provided in further embodiments, which are not shown in more detail. In step C), the damping layer 5 is bonded to the stability layer 4, preferably by means of pressing and/or laminating. For example, the damping layer 5, the stability layer 4 and the carrier plate 6 can be bonded, in particular adhered, to each other at the same time.

In method step D), which in the embodiment example shown in FIG. 6 is carried out chronologically after method steps B) and C), the stability layer 4 can be bonded to the upper layer structure 3, preferably by means of pressing and/or laminating.

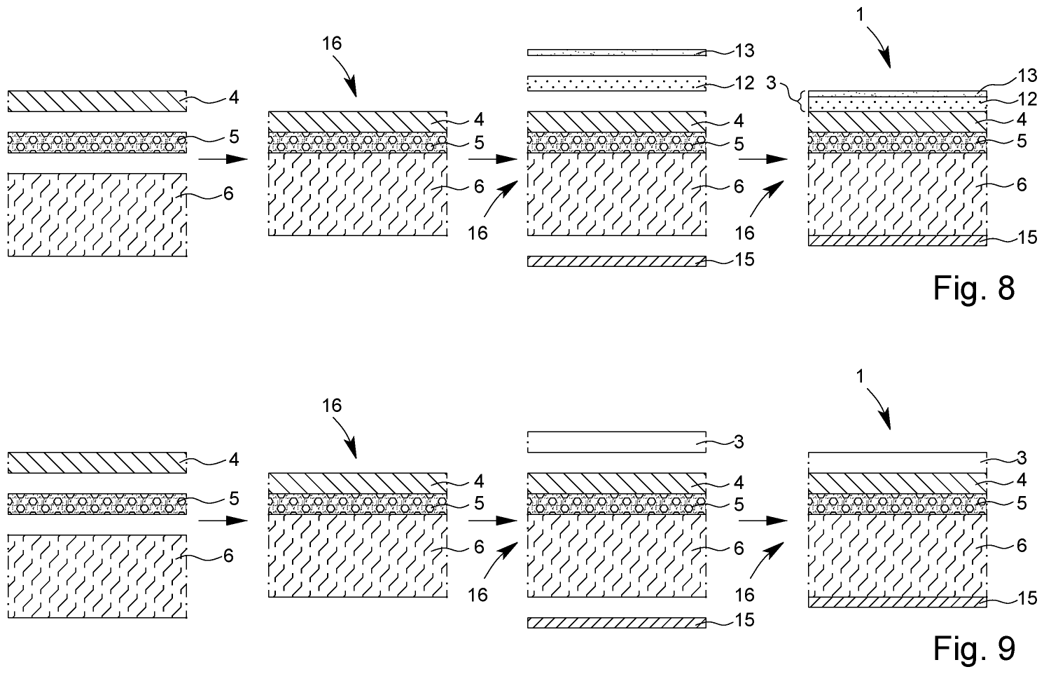

As explained above, method steps B) and C) can be carried out simultaneously. It is not shown in more detail that method steps C) and D) are also carried out alternatively or additionally at the same time. Also not shown in more detail is that the layers of the covering element 1 are pressed together and/or adhered together at least substantially simultaneously. In the embodiments of the method shown in FIGS. 8 to 10, it is provided that different preproducts 16 are provided for forming the covering element 1, which can be produced by bonding individual layers of the covering element 1, wherein these preproducts 16 can be bonded to further preproducts 16 or layers of the covering element 1.

The upper layer structure 3 may have been provided before bonding to the stability layer 4 or may be produced when bonded to the stability layer 4. If the upper layer structure 3 is formed in several parts, the upper layer structure 3 can be produced as such, in particular during the connection to the stability layer 4.

A preproduct 16 can be provided by bonding different layers of the covering element 1. Such a preproduct 16 can be intermediately stored, in particular, prior to bonding to other layers of the covering element 1. In FIG. 7, it is shown that a preproduct 16 can be produced by bonding, in particular adhering, the stability layer 4, the damping layer 5 and the carrier plate 6.

FIG. 10 again shows two preproducts 16. One preproduct 16 may have been produced by bonding the upper layer structure 3 to the stability layer 4 and another preproduct 16 may have been produced by bonding the carrier plate 6 to the carrier plate 15, in particular by pressing.

Not shown in more detail is that a preproduct 16 can also be provided by bonding the damping layer 5, the stability layer 4, and the upper layer structure 3, or by bonding the carrier plate 6 to the damping layer 5.

In particular, the provision of a preproduct 16 may be a function of the particular storage capacity or manufacturing method.

In addition, the connecting geometries 7 can be introduced at the edge sides into the carrier plate 6 and/or into the covering element 1 after the covering element 1 has been bonded. Alternatively, it is also possible for the edge sides of the carrier plate 6 to have the connecting geometries 7 before it is bonded to other layers.

FIGS. 8 to 10 show different schematic representations of a respective method.

FIG. 8 shows that a preproduct 16 can first be produced by bonding the stability layer 4, the damping layer 5 and the carrier plate 6. In particular, these layers can be bonded together by adhering. Subsequently, the preproduct 16 is pressed with the upper layer structure 3 and optionally with the countermove 15, in particular in a short-cycle pressing plant. In this context, it is particularly preferred if the countermove 15 and/or at least one layer, preferably the decorative layer 12, of the upper layer structure 3 is at least partially, preferably completely, resinated and/or impregnated through, especially preferably resinated, impregnated and/or soaked with melamine resin.

In particular, a melamine resin is provided as the resin.

If the layers are not treated with resin, a bonding layer (not shown in detail) is preferably arranged between the layers to be pressed. The bonding layer can then contain resin, in particular melamine resin, as the material and penetrate the adjacent layers during pressing.

FIG. 8 shows that the upper layer structure 3 is formed during pressing and is composed of the upper wear layer 13 and the decorative layer 12.

FIG. 9 shows that the preproduct 16 is first formed by bonding, in particular adhering, the stability layer 4, the damping layer 5 and the carrier plate 6. Subsequently, the upper layer structure 3, which can be formed in one or more layers, and optionally the countermove 15 are laminated to this preproduct 16. In the case of lamination, a laminating agent is provided that ultimately ensures a material bond. In this embodiment, the carrier plate 6 can have plastic as the material, but does not have to.

In FIG. 10, a further alternative method embodiment is again provided, in which two preproducts 16 are initially formed, wherein one preproduct 16 can be formed by pressing the upper layer structure 3 to form the stability layer 4, wherein the upper layer structure 3 can be formed in particular by a decorative layer 12 and an upper wear layer 13. The further preproduct 16 can be formed by bonding, in particular pressing, the carrier plate 6 to the countermove 15.

As previously discussed, it is particularly advantageous in a pressing process if at least one layer is treated and/or impregnated or if a resin bonding layer is provided between the layers to be pressed. Subsequently, the preproducts 16 are bonded, preferably adhered and/or laminated, to form the damping layer 5.

It is not shown in more detail that the damping layer 5 can also be formed already during extrusion onto the carrier plate 6 and subsequently adhered, laminated and/or pressed to form further layers.

### LIST OF REFERENCE SIGNS

1 Covering element
2 Covering
3 Upper layer structure
4 Stability layer
5 Damping layer
6 Carrier plate
7 Connecting geometries
8 Edge side of 1
9 Thickness from 4
10 Thickness from 5
11 Thickness from 6
12 Decorative layer
13 Upper wear layer
14 Wood cover layer/wood veneer layer
15 Countermove
16 Preproduct

1. A covering element for a floor, wall and/or ceiling covering, the covering element having:
an upper layer structure;
a stability layer of wood and/or of a wood-based material adjoining a rear side of the upper layer structure;
an elastic and/or acoustically damping layer adjoining a rear side of the stability layer; and
a carrier plate adjoining a rear side of the damping layer.

2. The covering element according to claim 1, wherein the covering element is designed to be PVC-free; and/or
wherein the stability layer is free of plastic and/or at least substantially free of plastic, with a plastic content in the material chosen from less than 5% by weight, less than 3% by weight, and less than 1% by weight.

3. The covering element according to claim 1, wherein the carrier plate has connecting geometries on the edge sides, in particular tongue-and-groove connecting geometries of a click connection, for connecting adjacent covering elements.

4. The covering element according to claim 1, wherein the stability layer has a thickness chosen from between 0.3 to 5 mm and between 0.5 to 2 mm; and/or
wherein the damping layer has a thickness chosen from between 0.3 and 5 mm and between 0.5 and 2 mm; and/or
wherein the carrier plate has a thickness chosen from between 2 to 15 mm, between 4 to 10 mm, and between 6 to 9 mm.

5. The covering element according to claim 1, wherein the upper layer structure has a decorative layer and/or an upper wear layer.

6. The covering element according to claim 1, wherein the upper layer structure comprises a wood veneer and/or a wood cover layer.

7. The covering element according to claim 1, wherein the stability layer is formed as a hard fiberboard and/or as a wood layer; and/or
wherein the stability layer is designed as a shaped fiberboard.

8. The covering element according to claim 1, wherein the damping layer comprises as material cork and/or a cork composite and/or a foam material and/or consists thereof; and/or
wherein the damping layer has a modulus of elasticity chosen from at most 5 MPa, between 0.2 and 5 MPa, and between 2 and 4 MPa.

9. The covering element according to claim 1, wherein a countermove is provided and/or arranged on an underside of the carrier plate; and/or
wherein the carrier plate is designed as a plate body chosen from an HDF and/or MDF board, and/or
wherein the carrier plate is designed as a plate body comprising or consisting of plastic.

10. The covering element according to claim 9, wherein the at least two layers of the covering element and/or the damping layer, the carrier plate, the stability layer, the countermove and/or the upper layer structure have been pressed together to form a laminate, at least one layer being treated with melamine resin; and/or
wherein at least two layers, preferably all layers, of the covering element have been adhered to one another with the carrier plate, the stability layer and the damping layer being adhered to one another.

11. Method A method for producing a covering element according to claim 1, the method comprising the following method steps:
A) Providing a carrier plate and a stability layer;
B) Bonding the carrier plate to a damping layer by extruding the damping layer at least indirectly onto the carrier plate and/or by pressing and/or laminating the carrier plate and the damping layer together;
C) Bonding the damping layer to the stability layer by means of pressing and/or laminating;
D) Bonding the stability layer to an upper layer structure by means of pressing and/or laminating.

12. The method according to claim 11, wherein the method steps B) and C) and/or C) and D) are carried out simultaneously.

13. The method according to claim 11, wherein the upper layer structure has been provided before bonding with the stability layer or is produced when bonding with the stability layer.

14. The method according to claim 11, wherein first the carrier plate, the damping layer and the stability layer are adhered to each other and subsequently pressed with the upper layer structure; or
wherein first the upper layer structure is pressed with the stability layer and then the damping layer is adhered with the stability layer and the carrier plate.

15. The method according to claim 11, wherein at least one preproduct is provided, the preproduct, being obtained by bonding the damping layer, the stability layer and the upper layer structure or by bonding the carrier plate to the damping layer or by bonding the stability layer to the upper layer structure or by bonding the carrier plate, the damping layer and the stability layer.

16. The covering element according to claim 3, wherein the carrier plate has connecting geometries of complementary design on opposite edge sides.

17. The covering element according to claim 5, wherein the decorative layer comprises a decorative film and/or a decorative paper and/or a decorative print and/or a decorative lacquer layer; and
wherein the upper wear layer comprises an overlay and/or a protective lacquer and/or protective oil and/or protective film.

18. The covering element according to claim 17, wherein the upper wear layer is formed as an overlay comprising polyurethane (PUR) and/or consisting thereof.

19. The covering element according to claim 7, wherein the stability layer is formed as a MDF and/or HDF board and/or as a HFM/MB and/or as a HFH/HB board; and/or
wherein the stability layer is designed as a shaped natural fiberboard comprising and/or consisting of recycled materials chosen from cellulose fibers and/or agricultural waste.

20. The covering element according to claim 8, wherein the damping layer comprises cork and polypropylene (PP), polyethylene (PE) and/or polyurethane (PUR) and/or other elastic plastics.
